(19) United States
(12) Patent Application Publication
(10) Pub. No.: US 2012/0091712 A1
(43) Pub. Date: Apr. 19, 2012

(54) Wind Powered System for Reducing Energy Consumption of a Primary Power Source

(76) Inventors: Ronald Hall, Woodstock (CA); John Bradley Ball, Lakeside (CA); Robert Allen Henry Brunet, Komoka (CA)

(21) Appl. No.: 13/145,905

(22) PCT Filed: Jan. 22, 2010
(86) PCT No.: PCT/CA2010/000103

§ 371 Date: Oct. 13, 2011

Related U.S. Application Data
(60) Provisional application No. 61/147,009, filed on Jan. 23, 2009.

(51) Int. Cl. F03D 9/00; H02P 9/04; F02B 65/00

(52) U.S. Cl. 290/44; 290/55; 60/398

(57) ABSTRACT

Provided is a wind powered system for reducing energy consumption of a power source, such as an internal combustion engine or an electric motor. In one embodiment, the wind powered system comprises a wind turbine operatively connected to an internal combustion engine, for example via a direct mechanical connection, a hydrostatic drive system or a pneumatic drive system in order to reduce the amount of fuel required by the engine to operate an electricity generating means. A controller may be optionally provided to modulate the load on the wind turbine in order to maximize the extraction of available power according to local wind conditions. In another embodiment, the wind turbine is connected to an air compressor for providing a supply of air in order to offset energy consumption of a conventional compressed air system.

### FIELD OF THE INVENTION

The invention relates to wind powered systems for generating supplemental power to offset the energy consumption of a primary power source. In certain embodiments, the invention relates to the interconnection between a wind powered apparatus and an electricity generator powered by a fuel consuming primary power source, such as an internal combustion engine, wherein the wind powered apparatus is used to offset some of the load on the primary power source, thereby decreasing the fuel consumption thereof to produce a given amount of electricity. In other embodiments, the invention relates to the interconnection between a wind powered apparatus and an air compressor or blower in order to reduce the energy consumption thereof.

### BACKGROUND OF THE INVENTION

Electric generators powered by internal combustion engines are used in a variety of mobile and stationary applications. For example, in remote communities diesel engine powered electric generators are used to provide power to the community and can be interconnected with a local electricity grid. Diesel fuel is expensive and in order to reduce the cost of the electricity generated, it would be desirable to reduce fuel consumption of the diesel engine. This is especially true in remote communities, since the cost of diesel fuel is increased due to shipping. An added benefit of reduced fuel consumption is an increased operating time from a given quantity of diesel fuel, which can be especially significant in remote communities where it may not be possible to regularly ship fuel throughout the year and the volume that can be shipped and stored at one time is limited.

Wind turbines are used for a number of applications, including flour milling, water pumping and electricity generation. It is known to provide electric power to remote communities using a combined wind powered and diesel electric generating system. However, in these systems, a relatively large wind turbine is provided in order to take the majority of the electrical load of the community and that turbine is equipped with its own electricity generator. Complicated control systems are used to regulate electricity production from each source. The wind turbine is normally considered the primary source of power and the diesel electric generator is a secondary or backup source of power, for use when the available wind is insufficient to satisfy the electrical demand of the community. It would be desirable, particularly for smaller systems, to eliminate the cost associated with having two generators and the complexity of control by providing a means to simply interconnect the wind turbine with the diesel engine in order to reduce fuel consumption thereof, regardless of the available amount of wind or electrical power demand.

Similarly, many commercial facilities utilize compressed air in their day to day operations. Compressed air is typically supplied by an air compressor connected to a reservoir or storage tank. The air compressor is often powered by an electric motor. Many commercial facilities are charged for electricity based on “time of day” metering, whereby the time of day and peak power usage of the facility determine the rate the facility pays for all of its electricity. In these situations, it would be advantageous to reduce the peak demand of the facility by reducing electricity demand for compressed air production in order to save money on all of the facility's electricity usage.

Other situations where it is advantageous to reduce energy consumption of a compressed air system are where compressed air is used in remote locations, such as in the pressure testing of oil and gas pipelines, where the compressor is powered by an internal combustion engine, such as a diesel engine. For the same reasons as enumerated above with respect to diesel powered generators, it would be advantageous in these situations to save fuel and extend operating time of the diesel powered compressors.

There are two types of wind turbines, horizontal axis wind turbines (HAWT's) and vertical axis wind turbines, or VAWT's. The most common type of large scale wind turbines used for electricity generation are HAWT's. However, for direct interconnection of a wind turbine with a diesel powered generator, a series of shafts and elbow connections are needed in order to transfer the rotary torque of the elevated main shaft to a rotary torque at ground level where the diesel engine is located. Each of these elbow connections represents a point of power loss and potential mechanical failure. Since the wind turbine is also required to rotate about its vertical axis in response to changes in wind direction, these connections can be difficult to establish in a robust and low maintenance manner. In addition, ice shedding can be a problem with conventional HAWT's, which is especially significant in remote communities in the Arctic. It would therefore be desirable to use a VAWT for direct interconnection with a diesel engine in order to avoid mechanical complexities, maintenance issues, and ice shedding.

There are generally two types of VAWT's, lift based, such as the Darrieus and Lenz types, or drag based, such as the Savonius type. Savonius turbines were invented by the Finnish engineer Sigurd J Savonius in 1922. Savonius turbines are one of the simplest turbines and have very little mechanical complexity. A simple Savonius turbine can be formed by taking a vertical cross section through a cylinder, then offsetting the two halves of the cylinder laterally from one another. Looking down on the turbine from above, it would have a generally “S” shaped cross section, although a small degree of overlap (typically 10-20% of the total diameter) is often provided. Although the Savonius turbine can include more than two of these semi-cylindrical rotor portions, most turbines have a maximum of three rotor portions. Because of the curvature, the scoops experience less drag when moving against the wind than when moving with the wind. The differential drag causes the Savonius turbine to spin. In larger models, a number of S-shaped sections can be stacked on top of one another, with each section being rotated about the central shaft relative to the one below. These types of turbines produce a large torque at relatively low speed with a relatively constant torque curve, making them well-suited to providing mechanical power. They are simple in construction and easy to maintain, making them well-suited to operation in remote locations. They are not often used for electricity generation due to concerns over their large size relative to their electrical output.

There is therefore a need for an improved system for reducing energy consumption of a primary power such, such as a diesel engine, particularly in electricity generation and air compression applications.

### SUMMARY OF THE INVENTION

According to the present invention, there is provided an electricity generating system comprising: an electricity generating means operatively connected to an internal combustion engine; and, a wind turbine operatively connected to the internal combustion engine.

The electricity generating means may comprise an AC or DC alternator or generator. Although any energy consuming prime mover producing a rotary output qualifies as a primary power source suitable for use in the present invention, electric motors or internal combustion engines are the most common types of such primary power sources. Internal combustion engines suitable for use with the present invention may be of the reciprocating piston type or rotary type. Suitable fuel sources for the internal combustion engine include: diesel fuel, bio-diesel fuel, or blends thereof; gasoline, alcohol or blends thereof; compressed gases such as natural gas, methane or propane, etc. A particularly preferred type of primary power source is an internal combustion diesel cycle reciprocating piston engine.

The wind turbine may be operatively connected to the internal combustion engine by means of any suitable drive system, for example a direct mechanical connection, a pneumatic drive system, an electric drive system or a hydraulic drive system. The drive system may provide power directly to the internal combustion engine. The pneumatic drive system may comprise an air compressor and an air motor pneumatically connected to one another. The electric drive system may comprise and alternator or generator electrically connected to an electric motor. The hydraulic drive system may comprise a hydraulic pump powered by the wind turbine and a hydraulic motor in fluid communication with the pump (via hydraulic fluid conduits). The hydraulic motor may be mechanically connected to the internal combustion engine via a crankshaft of the engine or via a camshaft of the engine. In this later embodiment, the hydraulic motor may be connected via an auxiliary power port that is internally interconnected with the camshaft and normally used to power a hydraulic pump, but can be operated in reverse to supply power to the engine.

The wind turbine may comprise a horizontal axis wind turbine or a vertical axis wind turbine. The wind turbine may comprise a vertical axis wind turbine of the lift or drag type. Examples of lift based VAWT's include the Darrieus and Lenz type and of drag based VAWT's include the Savonius type. The wind turbine may comprise a vertical shaft and the hydraulic pump, air compressor or generator may be located beneath the turbine and may vertically accept the connection with the shaft. This advantageously eliminates the number of elbow connections in the main shaft, which each represent a point of power loss and potential mechanical failure. This also advantageously leads to a compact design with the main components of the drive system located substantially at ground level for ease of maintenance.

The system may further comprise a controller that varies the amount of load applied to the wind turbine according to available wind energy. In embodiments equipped with a hydraulic drive system, the variation in load may be accomplished using a bypass loop with a variable valve or by means of a squash plate to permit internal bypassing within the hydraulic pump. The controller may accept a measurement of power produced by the turbine and may periodically or continuously vary the load applied to the turbine in order to seek a maximum power output of the turbine. The measurement of power may be provided by an electronic engine control system of the internal combustion engine. Alternatively or additionally, the controller may be programmed with a torque curve of the wind turbine (torque as a function of rotational speed, or a similar curve analogous thereto), may accept a measurement of torque produced by the turbine (for example, from a shaft torsion sensor), may accept a measurement of rotational speed of the turbine (for example, from an optical encoder or Hall effect transducer), may calculate a power produced by the turbine and periodically or continuously vary the load applied to the turbine in order to seek a maximum power output of the turbine. The controller may alternatively or additionally accept a measurement of wind speed (for example, from an anemometer) and may be programmed with a speed curve (relating the rotational speed that produces maximum power to wind speed, or a similar curve analogous thereto), may accept a measurement of rotational speed of the turbine and may vary the load applied to the turbine to match a target rotational speed derived from the speed curve that produces maximum power for the measured wind speed.

The system is normally operated with the internal combustion engine as the main source of power for the electricity generating means. The wind turbine is normally sized to be smaller in output than the internal combustion engine and provides supplemental power to the internal combustion engine for fuel savings. For example, the expected maximum power output of the wind turbine, according to local wind conditions, may be less than 100% of the base load (or minimum electrical load) on the electricity generating means, optionally less than 90%, less than 80%, less than 70% or less than 60% of the base load. The expected maximum power output of the wind turbine may be less than 50% of the rated maximum power of the internal combustion engine, optionally less than 40%, less than 30%, less than 25%, or less than 20% of the rated maximum power. A control system may be provided for the electricity generating means that provides feedback control to the internal combustion engine, but does not provide feedback control to the wind turbine. The control system for the electricity generating system may be independent of the wind turbine. Similarly, the wind turbine control system may operate independently of the electrical demand on the electricity generating means.

According to another aspect of the invention, there is provided a wind powered apparatus comprising: a vertical axis wind turbine having a vertical shaft; a hydraulic drive system comprising a hydraulic pump powered by the wind turbine and a hydraulic motor fluidly connected to the hydraulic pump, the hydraulic pump located beneath the wind turbine and vertically accepting the vertical shaft of the wind turbine; and, the hydraulic motor operatively connectable to a mechanical load.

The apparatus may further comprise a controller that varies the amount of the load applied to the wind turbine via the hydraulic drive system according to available wind energy, substantially as previously described. The mechanical load may comprise an electricity generating means. The mechanical load may comprise an air compressor or blower that may supply compressed air to a storage reservoir, optionally for further use in powering a pneumatic motor or other pneumatic load. The mechanical loads may be operatively connected to an internal combustion engine.

According to yet another aspect of the invention, there is provided a system for reducing energy consumption of a primary power source comprising: a wind powered apparatus comprising a wind turbine having a hydraulic drive system comprising a hydraulic pump powered by the wind turbine and a hydraulic motor fluidly connected to the hydraulic pump, the hydraulic motor for reducing a load on the primary power source to thereby reduce energy consumption thereof; and, wherein the hydraulic motor reduces load on the primary power source either by providing power directly to the primary power source or by separately satisfying a portion of the load on the primary power source.

### BRIEF DESCRIPTION OF THE DRAWINGS

Having summarized the invention, preferred embodiments thereof will now be described with reference to the accompanying figures, in which:

FIG. 1 shows a system according to the invention comprising a wind turbine operatively mechanically connected to an internal combustion engine powering an electricity generating means;

FIG. 2 shows a system and apparatus according to the invention comprising the wind turbine depicted in FIG. 1 operatively connected to a hydraulic pump connected by means of fluid conduits to a hydraulic motor for providing power to the internal combustion engine;

FIG. 3a shows the system and apparatus of FIG. 2 with an embodiment of a controller according to the present invention;

FIG. 3b shows the system and apparatus of FIG. 2 with another embodiment of a controller according to the present invention;

FIG. 3c shows the system and apparatus of FIG. 2 with yet another embodiment of a controller according to the present invention;

FIG. 4a illustrates a representative power curve, relating power and rotational speed, for a wind turbine according to the invention at a number of different wind speeds;

FIG. 4b illustrates a representative maximum power curve, relating maximum power to the rotational speed that produces that power, for a wind turbine according to the invention;

FIG. 4c illustrates another representative maximum power curve, relating the rotational speed that produces maximum power to the prevailing wind speed, for a wind turbine according to the invention;

FIG. 5 shows a perspective view of the internal combustion engine depicted in FIGS. 1-3, 6 and 8c-11 with a hydraulic motor operatively connected;

FIG. 6 shows a system according to the invention comprising a pneumatic drive system for powering the internal combustion engine depicted in FIG. 5;

FIG. 7 shows a wind powered apparatus comprising a wind turbine equipped with a hydraulic drive system for powering an air compressor, air receiving reservoir, and pneumatic load;

FIG. 8a shows a system and apparatus according to the invention comprising the wind powered apparatus of FIG. 7 and a second air compressor;

FIG. 8b shows a system and apparatus according to the invention comprising the system and apparatus of FIG. 8a along with a second air reservoir;

FIG. 8c shows a system and apparatus according to the invention comprising the wind powered apparatus of FIG. 7 and an air compressor powered by an internal combustion engine;

FIG. 9 shows a system and apparatus according to the invention comprising the wind powered apparatus of FIG. 7, wherein the pneumatic load is an air motor used to power an internal combustion engine connected to an electricity generating means;

FIG. 10 shows the system and apparatus of FIG. 9, further comprising a controller according to the present invention;

FIG. 11 shows a system according to the present invention with a HAWT operatively mechanically connected to an internal combustion engine powering an electricity generating means; and,

FIG. 12 shows a schematic representation of an alternative configuration for use with the preceding embodiments, permitting power to be supplied from a hydraulic motor in parallel with an internal combustion engine.

### DETAILED DESCRIPTION

Throughout the detailed description, like reference numerals will be used to describe like features. Certain reference numerals appearing on a given drawing may in fact be described with reference to another drawing.

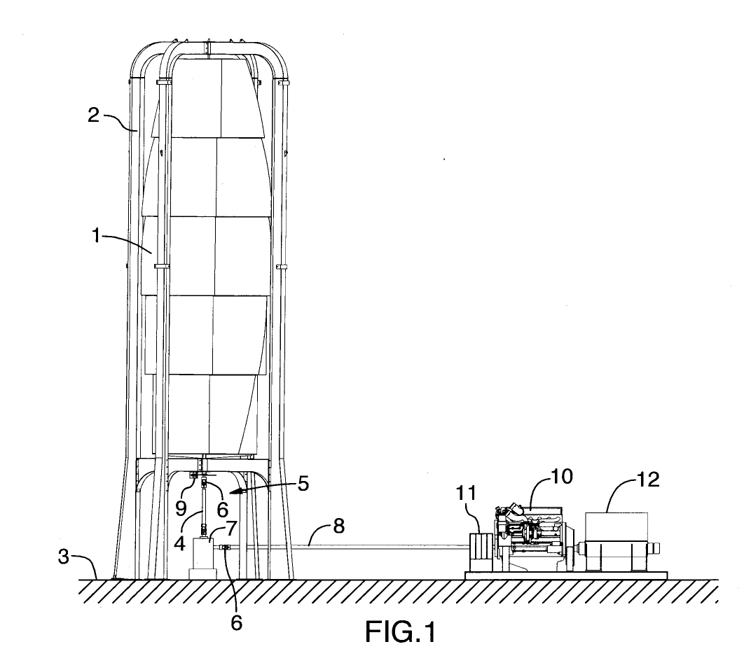

Referring to FIG. 1, a wind turbine 1 comprising a VAWT of the Savonius type is shown. The turbine 1 is secured within a mounting structure 2 that elevates the turbine relative to ground level 3. The turbine 1 has a vertical shaft 4 extending downwardly along the vertical centerline of the turbine to protrude beneath the turbine into the space 5 created within the boundary of the mounting structure 2 between the turbine 1 and ground level 3. Preferred embodiments of a turbine 1 suitable for use with the present invention are disclosed in co-pending U.S. patent application 61/053,018, which was filed on May 14, 2008, now U.S. Pat. No. 12/465,644, and in co-pending U.S. patent application 61/241,399, filed Sep. 11, 2009, all of which are incorporated herein by reference.

A safety brake 9 is provided on the vertical shaft 4 to allow the turbine 1 to be slowed or halted during exceptionally high winds or for periodic maintenance.

The vertical shaft 4 is connected to a gear box 7 that serves to both increase the rotational speed of the exit shaft 8 exiting the gear box 7 (relative to the rotational speed of the vertical shaft 4) and also allows a 90° corner to be made so that the exit shaft 8 can extend outwardly from the space 5 in order to permit connection to other equipment. The speed ratio between the vertical shaft 4 and the exit shaft 8 can be fixed or variable and can be from 1× to 1000×, preferably from 2× to 100×, more preferably 5× to 50×, yet more preferably from 10× to 25×. The gear box may optionally comprise a clutch and means to shift between the various gear ratios, either periodically or continuously. The shafts 4, 8 comprise universal joints 6 that permit any misalignment between equipment at opposite ends of the shafts 4, 8 to be compensated for without introducing a bend in the shaft. The universal joints 6 may optionally comprise splined couplings to permit ready disassembly and assembly of the interconnected equipment for maintenance purposes.

The exit shaft 8 extends outwardly from beneath the turbine 1 and is mechanically connected to an internal combustion engine 10, which is of the diesel type, via a transmission 11. The transmission may be of any suitable type that permits substantially infinite adjustment of its output rotational speed within its operating range, for example a continuously variable transmission (CVT), a hydrostatic transmission, etc. The operating range of the transmission 11 is within a ratio of output to input speed of from 1× to 1000×, preferably from 5× to 500×, more preferably 10× to 200×, yet more preferably from 15× to 150×, even more preferably 20× to 100×. The transmission 11 is shown connected directly to a crank shaft of the engine 10. In this embodiment, feedback from the engine 10 is provided to the transmission 11 in order to allow a speed to be selected that matches the rotational speed of the crank shaft. This allows the power generated by the wind turbine 1 to be transferred to the crankshaft without affecting its speed. If insufficient wind is available, a clutch within the transmission 11 or gear box 7 may be disengaged to allow the exit shaft 8 to spin freely without transferring its power to the transmission 11. At the opposite end, the engine 10 is connected to an electricity generating means 12. The electricity generating means 12 supplies power to connected electrical loads and provides feedback to the engine 10 in order to adjust its power output according to the demand of the downstream loads. This feedback to the engine 10 is independent of the wind turbine 1; there is no control of the wind turbine 1 according to demand on the electricity generating means 12, nor any control of the electricity generating means 12 based upon available wind power from the wind turbine 1.

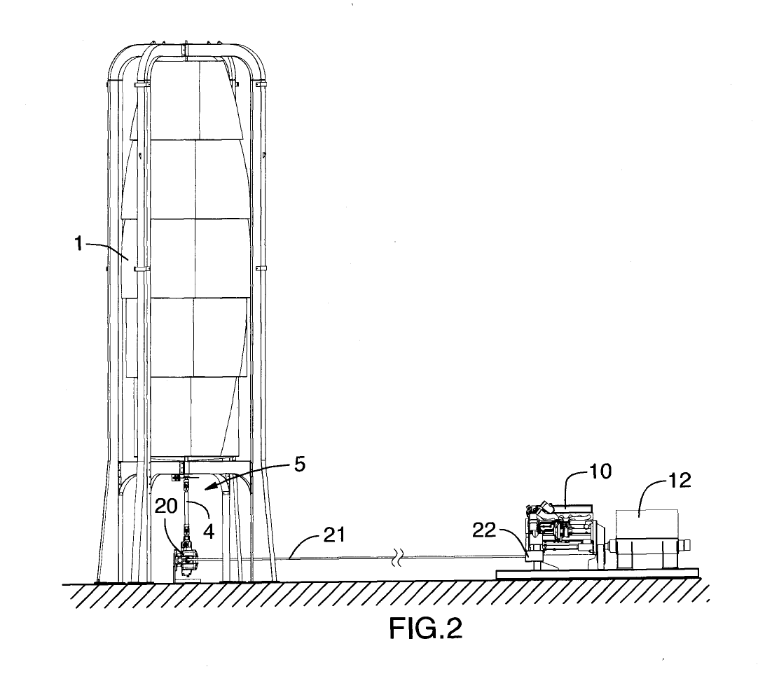

Referring to FIG. 2, another embodiment of the invention is shown comprising a hydraulic drive system. A hydraulic pump 20 is provided in the space 5 beneath the wind turbine 1. The hydraulic pump 20 vertically receives the downwardly extending vertical shaft 4; this advantageously eliminated the need for a gear box to make the 90° corner, since such gear boxes always entail some amount of power loss. The hydraulic pump 20 generates hydraulic fluid pressure in fluid conduits 21, which can comprise at least a portion of flexible conduit to simplify installation. The fluid conduits 21 create a continuous loop between the hydraulic pump 20 and a hydraulic motor 22 that is mounted to the engine 10. A preferred means of mounting the hydraulic motor 22 is via an auxiliary power port (not shown) of the engine 10; this port is normally provided for powering a hydraulic pump for delivering hydraulic fluid power externally of the engine 10, but can be simply and advantageously operated in reverse by the hydraulic motor 22 to supply hydraulic fluid power to the engine 10. The hydraulic fluid power supplied to the engine, in certain engine designs, transfers the power to the crankshaft via the camshaft of the engine. This approach represents a simple way of providing power to the engine 10 with minimal modification thereto using pre-existing components and mounting configurations. The hydraulic fluid power supplied to the engine 10 offsets the need for fuel consumption within the engine 10 to generate the power demanded by the loads on the electricity generating means 12. In this way, power developed by the wind turbine 1 is transferred via the hydraulic pump 20, fluid conduits 21 and hydraulic motor 22 to the engine 10 to reduce fuel consumption thereof, irrespective of the loads on the electricity generating means 12.

It is, of course, understood by persons skilled in the art that other components of a hydraulic fluid power system may be provided, even if not explicitly shown in this simple schematic, for example reservoirs, accumulators, pressure and/or flow measurement gauges, shut off valves, etc.

It is preferable that the amount of power generated by the wind turbine 1 is relatively smaller than the base load on the electricity generating means 12, which is the minimum amount of power generated by the engine 10. It is preferable that the expected maximum amount of power generated by the wind turbine 1 is less than 100% of the base load on the electricity generating means. Since the maximum power output of the engine is sized so that it is larger than the maximum expected electrical demand, due to conversion losses, the expected maximum power output of the wind turbine is preferably less than 50% of the rated maximum power of the internal combustion engine. To operate in this manner requires little or no modification to the controls of the engine 10.

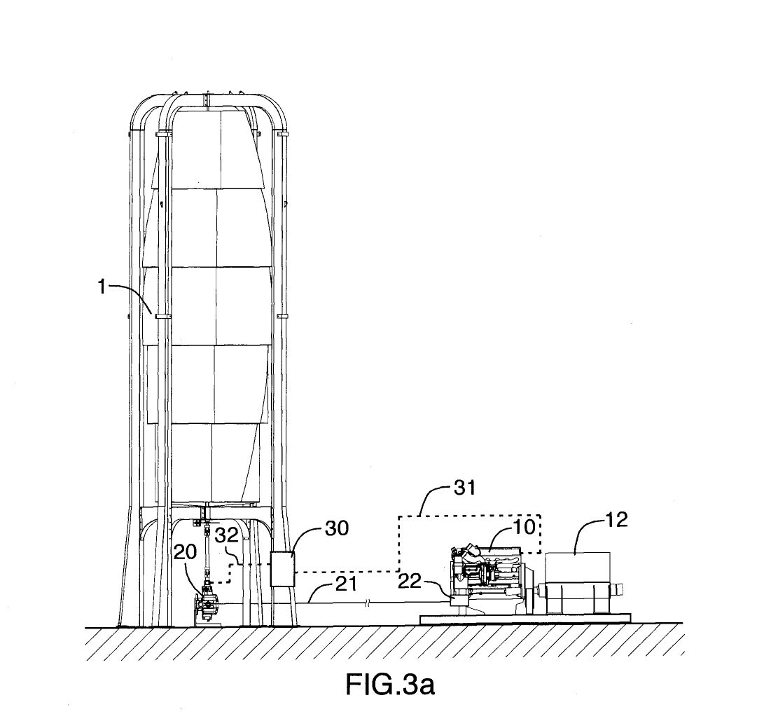

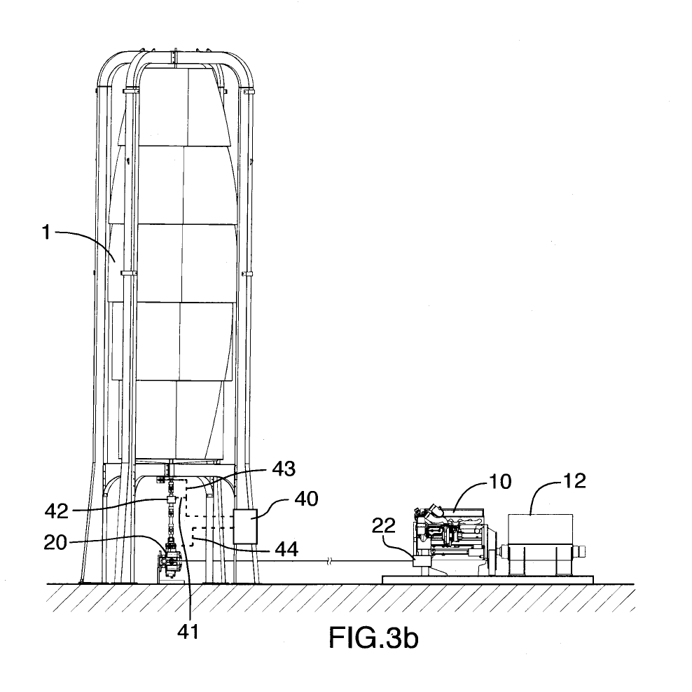

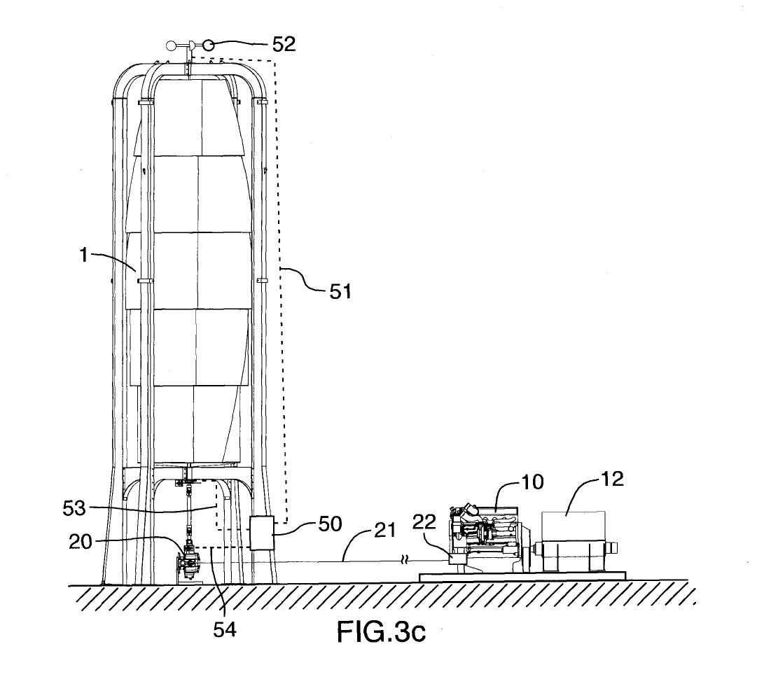

Referring to FIG. 3a, a schematic representation of one type of controller 30 suitable for use with the present invention is shown. In this embodiment, the controller 30 receives a power measurement 31 from an engine management system (a computerized system either on-board the engine 10 or connected thereto) for monitoring performance of the engine 10. The measurement of power relates to the difference between the amount of power demanded by the electricity generating means 12 and the amount of power actually created by the internal combustion engine 10, the difference being due to power provided by the hydraulic motor 22. This net power provided by the hydraulic motor 22 can be obtained, for example, by a savings in fuel consumption as compared with what is expected by the engine management system according to the demand on the engine 10, or as a direct or indirect measurement of power provided by the hydraulic motor 22 via the auxiliary power port. Upon receiving the power measurement 31 from the engine management system, the controller 30 incrementally increases or decreases the load on the pump 20 (via control line 32) in order to maximize the power provided by the hydraulic motor 22. This variation in load can be accomplished through a variety of means, for example using a “squash plate” internal or external to the pump that varies the amount of hydraulic fluid bypassing between the pump inlet and the pump outlet, a variable valve that controls pressure in the fluid conduits 21 between the pump 20 and motor 22, or a combination thereof. By continuously seeking maximum power delivery from the hydraulic motor 22 to the engine 10, the controller 30 optimizes the load on the wind turbine 1 in order that it extracts maximum power from the available amount of wind without stalling or permitting over-speed of the turbine 1.

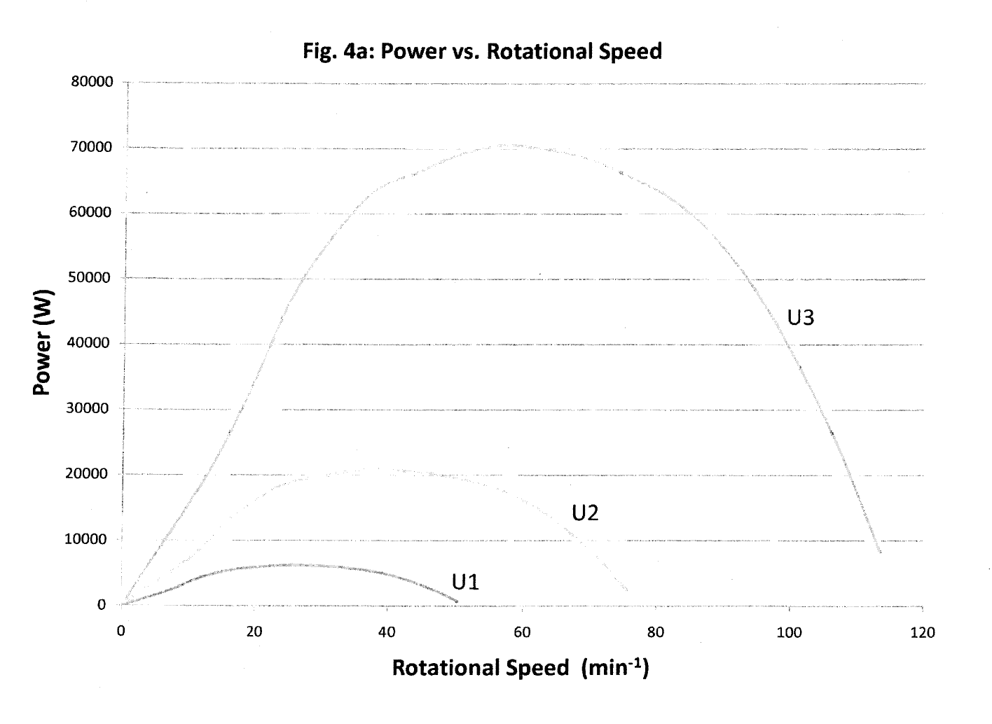

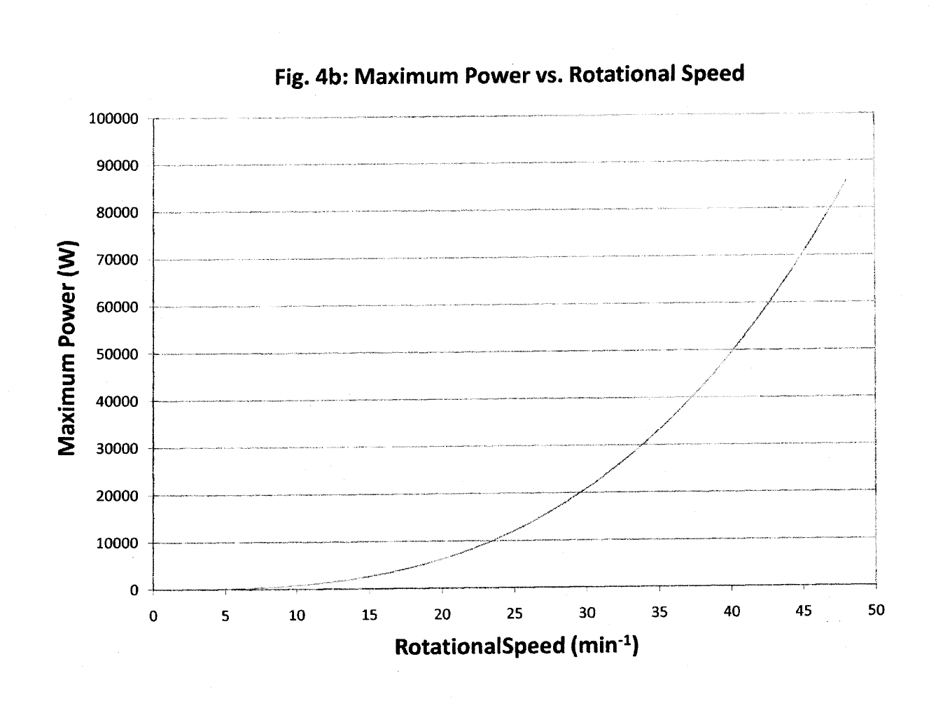

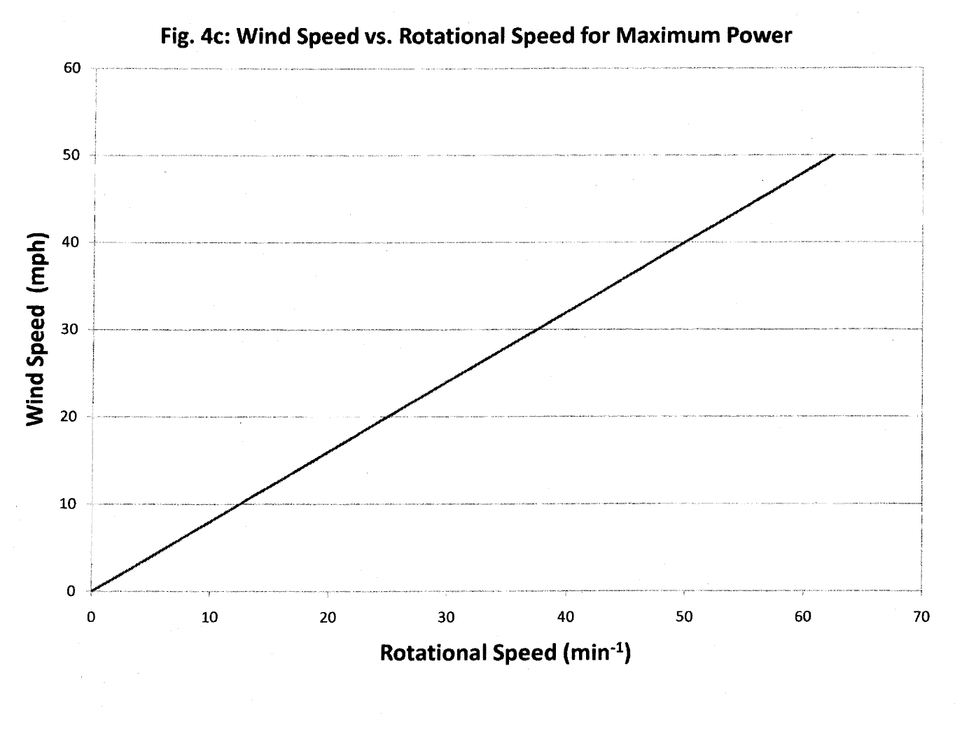

Referring to FIG. 4a, a representative power curve for a wind turbine is shown with power on the ordinate (vertical) axis in kW and rotational speed on the abscissa (horizontal) in rpm for three increasing wind speeds, U1, U2 and U3. Each power curve has an approximately inverted parabolic shape. As can be seen from the figure, as wind speed increases from U1 to U3, absolute maximum power increases, but the rpm at which this power is developed also increases. So, in order for the wind turbine to develop its maximum power, as the wind speed changes the load on the turbine must be increased or decreased in order to allow it to spin at the rpm that generates peak power for the current wind speed. Referring to FIG. 4b, which has the same axes as FIG. 4a, but plots the maximum power values obtained at a plurality of different wind speeds, the maximum power values take on a cubic function with ever increasing maximum power as rpm (and wind speed) increase.

A controller that relies on a measurement of output power can be designed to “hunt”, constantly increasing or decreasing load on the turbine and comparing the difference in power readings; if the difference is small, then the turbine 1 is operating at a local maximum of whichever power curve (as shown in FIG. 4a, U1, U2 or U3) is applicable according to current wind speed. Therefore, without knowing current wind speed or the power curve information of either FIG. 4a or 4b, this control method will eventually optimize load to achieve maximum power. However, power measurements can sometimes be relatively slow to react as compared with changes in wind speed, due at least in part to inertia of the wind turbine 1, and this method can therefore produce less responsive control in gusty locations.

Another method of controlling the load on the wind turbine 1 is schematically depicted with reference to FIG. 3b. In this method, the controller 40 receives torque measurements 41 from a torque sensor 42. The torque sensor may be of any suitable type, but preferably comprises a shaft torsion strain gauge mounted in line with the vertical shaft 4 to thereby permit a “live” measurement of torque produced by the wind turbine 1 without affecting the torque during the measurement. A measurement of rotational speed 43 is also provided, either by the torque sensor 42 or by a separate Hall effect sensor or optical relay as indicated in FIG. 3b. The controller 40 calculates power by obtaining the product of torque and rotational speed and then functions as previously described for controller 30, continuously varying the load on the pump 20 (via control line 44) in order to obtain maximum power, irrespective of knowing the wind speed or power curve parameters of the wind turbine. This method may produce more consistently accurate control, particularly in gusty locations, due to the responsive and more direct power measurements obtained using the torque sensor 42.

Still referring to FIG. 3b, in an alternative embodiment the controller 40 may be programmed with a maximum power curve for the wind turbine 1, as previously described and shown with reference to FIG. 4b. Rather than continuously varying the load on the pump 20 in order to seek a maximum power, the controller can vary the load until the power and rpm values match (within acceptable tolerance) the values provided on the curve. Since there is only one rpm value that provides maximum power for any given wind speed, by adjusting load until the power and rpm values align, the controller 40 does not need to continuously “hunt” for the maximum and this can further improve accuracy of control, particularly in gusty environments.

Yet another embodiment of a controller suitable for use with the present invention is schematically depicted with reference to FIG. 3c. In this embodiment, the controller 50 is programmed with a maximum power curve as illustrated, by way of example, in FIG. 4c. This maximum power curve relates wind speed to the rotational speed (e.g. rpm) that produces maximum power. A measurement of wind speed 51 is obtained from an anemometer 52 that may be mounted atop the turbine 1 for convenience, but is preferably mounted remotely from the turbine 1 in order to reduce interference with the measurements. A measurement of rotational speed, 53, of the vertical shaft 4 is obtained from a suitable sensor, as previously described with reference to FIG. 3b. The wind speed 51 is compared with the maximum power curve and a target rpm value is obtained. The controller 50 adjusts the load on the pump 20 (via control line 54) until the target rpm is reached. This control methodology may produce accurate results, provided that the anemometer 52 is maintained in a calibrated state.

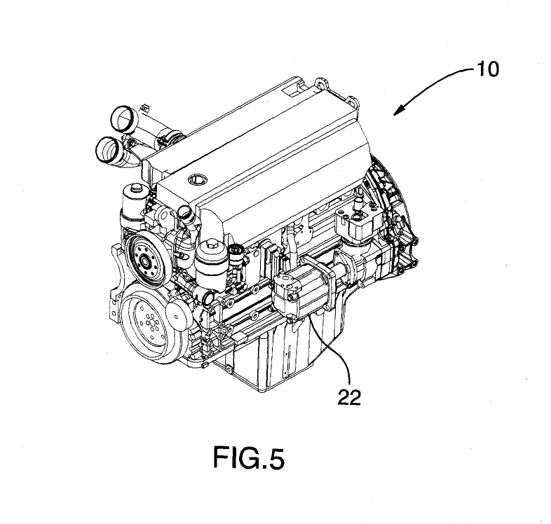

Referring to FIG. 5, an example of an internal combustion engine 10 suitable for use with the present invention is shown. The engine 10 is depicted with a hydraulic motor 22 mounted to the engine 10 and connected thereto via an auxiliary power port. The auxiliary power port is normally provided to output power from the engine 10 to an optional hydraulic pump (not shown); however, when operated in reverse, the auxiliary power port can be used to supply power to the engine 10. The auxiliary power port is connected to a cam shaft of the engine 10, which is robustly connected to the crankshaft and allows the power transmitted through the port to be delivered to the crankshaft. Power delivered in this manner is transferred to the electricity generating means 12 and thereby offsets the power needed from fuel combustion. This has the effect of reducing fuel consumption of the engine 10 in order to achieve its operating objectives. Connecting the hydraulic motor 22 in this fashion is simple and requires minimal or no changes to the engine management system or the control system operating between the electricity generating means 12 and the engine 10. It is to be noted that the mounting position of the hydraulic motor 22 need not necessarily be as shown in FIG. 5 and that other mounting positions are possible that either do or do not take advantage of the auxiliary power port. Although use of the auxiliary power port is preferred, other options are available, such as providing power directly to the crankshaft.

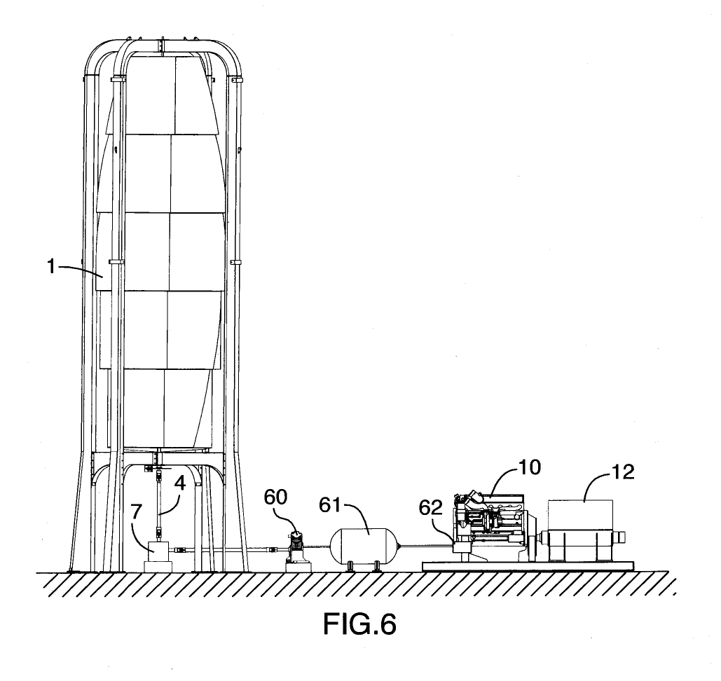

Referring to FIG. 6, in another embodiment of the present invention a pneumatic drive system is shown comprising an air compressor 60. The air compressor 60 is mechanically driven by the wind turbine 1. A gearbox 7 (as previously described with reference to FIG. 1) is provided, optionally with a 90° elbow connection, as shown, in order to provide an appropriate rotational speed for the air compressor 60. The air compressor 60 may be of any suitable type and may comprise a reciprocating compressor, a rotary compressor, a blower or a combination thereof provided as separate units operable at different times according to available wind energy and/or rotational speed of the turbine 1. In the embodiment shown, the air compressor 60 operates at a variable speed, according to the speed of the wind turbine 1 and the gear ratio provided by the gearbox 7. Compressed air discharged from the air compressor is provided to an air reservoir 61. The reservoir is not normally sized to provide a significant amount of storage capacity, but rather for buffering of fluctuations in pressure and/or flow caused by variations in rotational speed of the compressor 60. Compressed air from the reservoir 61 is provided to a pneumatic motor 62, which is part of the pneumatic drive system connected to the internal combustion engine 10, in order to provide supplemental power to the engine 10 from the wind turbine 1. The pneumatic drive system decreases the amount of fuel needed to provide power to the electricity generating means 12, as previously described with reference to the preceding embodiments. The pneumatic motor 62 may be connected to the engine 10 via an auxiliary power port, as previously described.

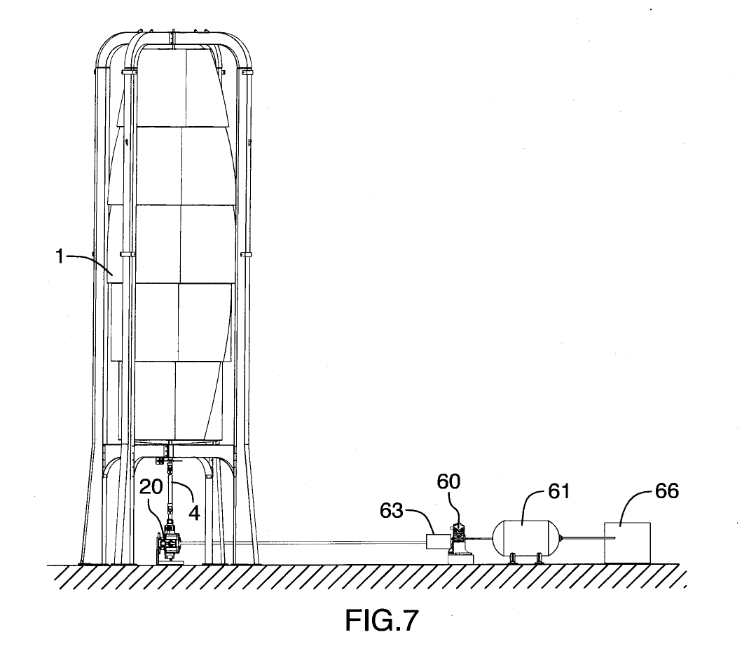

Referring to FIG. 7, in another embodiment of the invention, the air compressor 60 may be connected to the wind turbine 1 by means of a hydrostatic drive system comprising a hydraulic pump 20 that is mechanically connected to the vertical shaft 4 of the turbine 1 and in fluid communication with a hydraulic motor 63 that is interconnected with the air compressor 60. The air compressor 60 provides compressed air to a reservoir 61 that in turn supplies air to a pneumatic load 66 that may comprise, for example, one or more air motors, pneumatic tools, pneumatic cylinders, etc.

Use of a hydrostatic drive system for powering the air compressor 60 has several advantages as compared with a direct mechanical connection. Firstly, the hydrostatic drive system provides a variable speed ratio between the vertical shaft 4 and the air compressor 60, allowing an appropriate load to be readily applied to the turbine 1 to generate maximum power. Secondly, the use of a pump 20 that accepts a vertical connection eliminates the need for a 90° elbow, which can introduce unnecessary power loss into a mechanical drive system. Thirdly, the use of a fluid interconnection permits greater flexibility in locating the air compressor 60, which may be located within a building, such as a factory facility or agricultural facility, remote from the turbine 1.

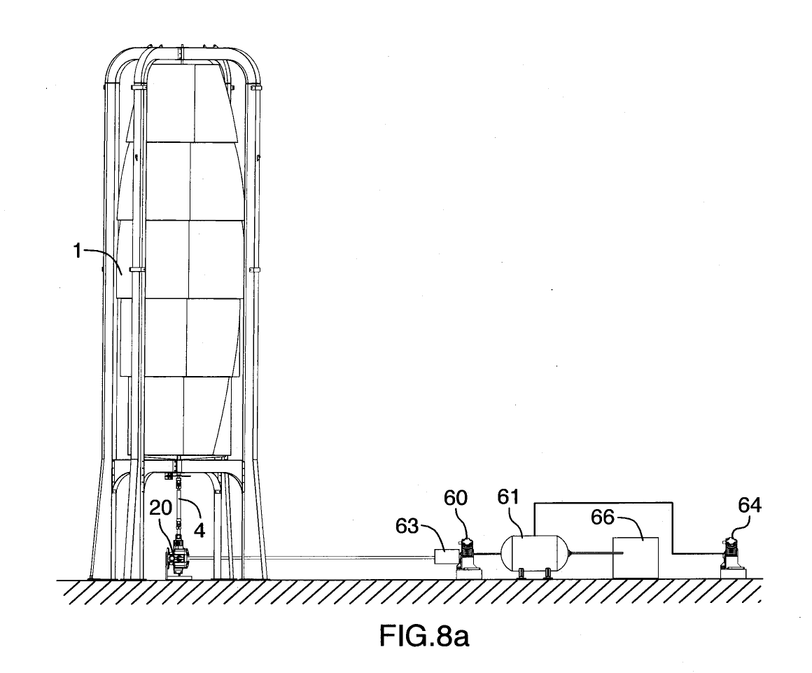

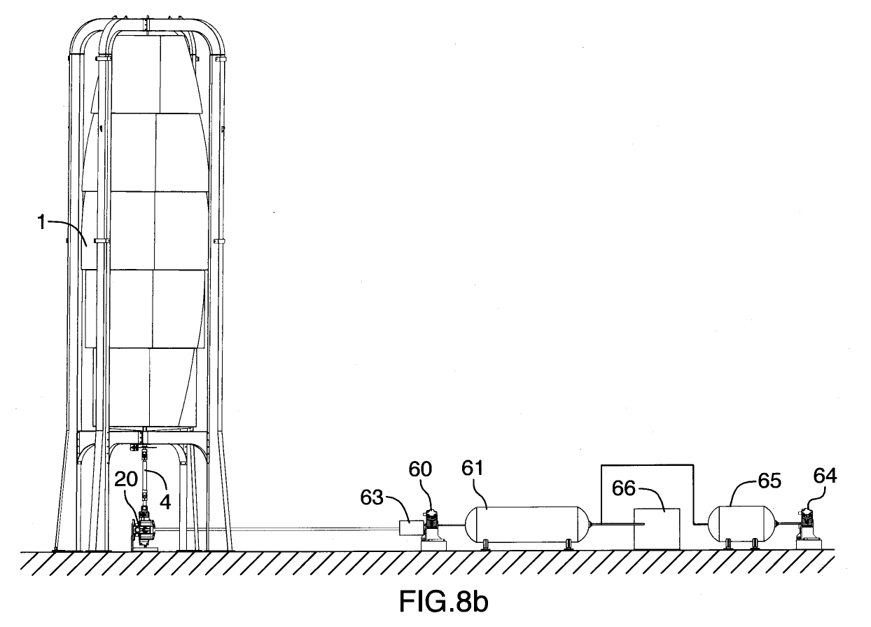

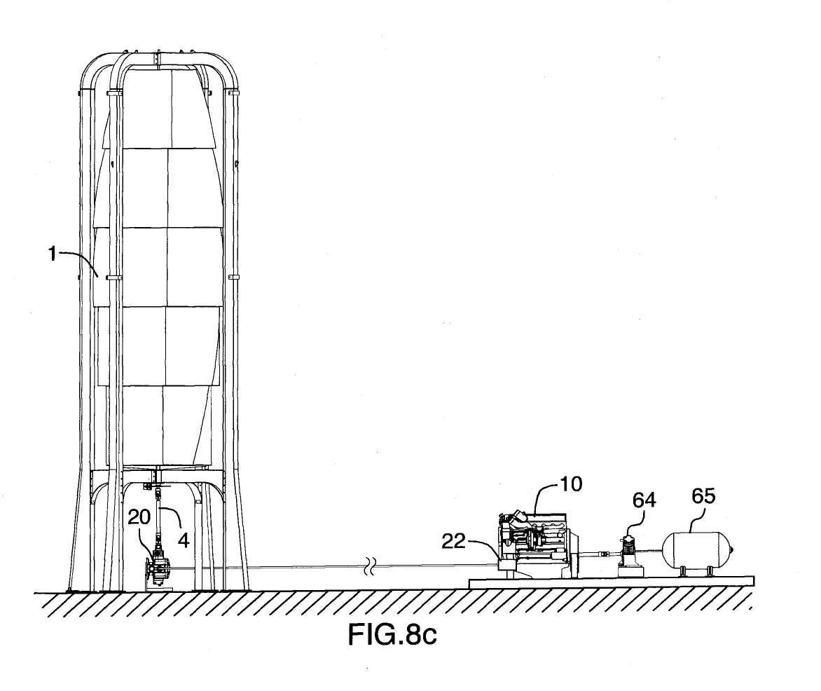

Use of a hydrostatic drive system is particularly suitable when adapting or retrofitting a compressed air system to accept wind power as a supplement to an existing power source. There are several ways in which this can be accomplished. Referring to FIG. 8a, the air compressor 60 may be pneumatically connected to an existing reservoir 61 in parallel with a second air compressor 64. In this embodiment, the air compressor 64 may be an existing compressor and the reservoir 61 may be an existing reservoir that is already sized for the compressed air demand of the pneumatic load 66, so that the reservoir 61 accepts air from both the air compressor 60 and the second compressor 64 and the energy demand or load upon the second compressor 64 is thereby reduced. A variation on this embodiment, shown in FIG. 8b, is to provide the reservoir 61 in parallel to a second reservoir 65, supplied by the second compressor 64, in order to allow the reservoir 61 to be relatively larger in size to permit storage of compressed air created using wind power during off peak periods of operation of the facility. This allows a greater reduction in load upon the second compressor 64 during peak operating periods, which can be of particular interest to facilities that are charged for electrical energy based on time of day metering. In another embodiment, shown in FIG. 8c, the second air compressor 64 may be powered by an internal combustion engine 10. A hydraulic drive system comprising a hydraulic pump 20 and a hydraulic motor 22 is directly connected in series to the internal combustion engine 10 in a manner as previously described with reference to FIG. 2 (for example, via an auxiliary power port) to offset the fuel consumption of the internal combustion engine 10. In all of these embodiments, wind power is supplied to a primary power source (usually, either an electric motor or an internal combustion engine) either by satisfying the demand of a load connected to the power source in parallel or by providing the power directly to the power source directly in series in order to reduce the load thereon. Consequently, the energy consumption of the primary power source is reduced.

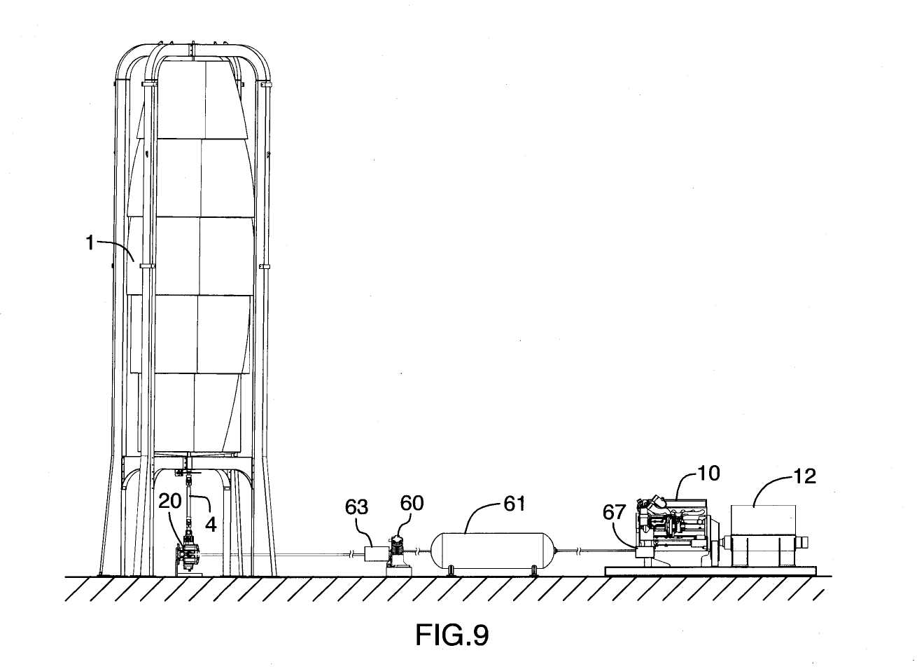

Referring to FIG. 9, a combination of the embodiments of FIGS. 6 and 7 is shown wherein a hydrostatic drive system comprising a hydraulic pump 20 connected to the vertical shaft 4 of the turbine 1 is used to provide hydraulic fluid power to a hydraulic motor 63 connected to an air compressor 60. The air compressor 60 is part of a pneumatic drive system that comprises a reservoir 61 for delivering air to an air motor 67 providing supplemental power to an internal combustion engine 10 connected to an electricity generating means 12. In this embodiment, the reservoir 61 is sized for storage of compressed air generated during off peak electricity consumption periods so that it can be used to provide supplemental power to the engine 10 during peak electricity consumption periods, thereby increasing the potential for fuel savings.

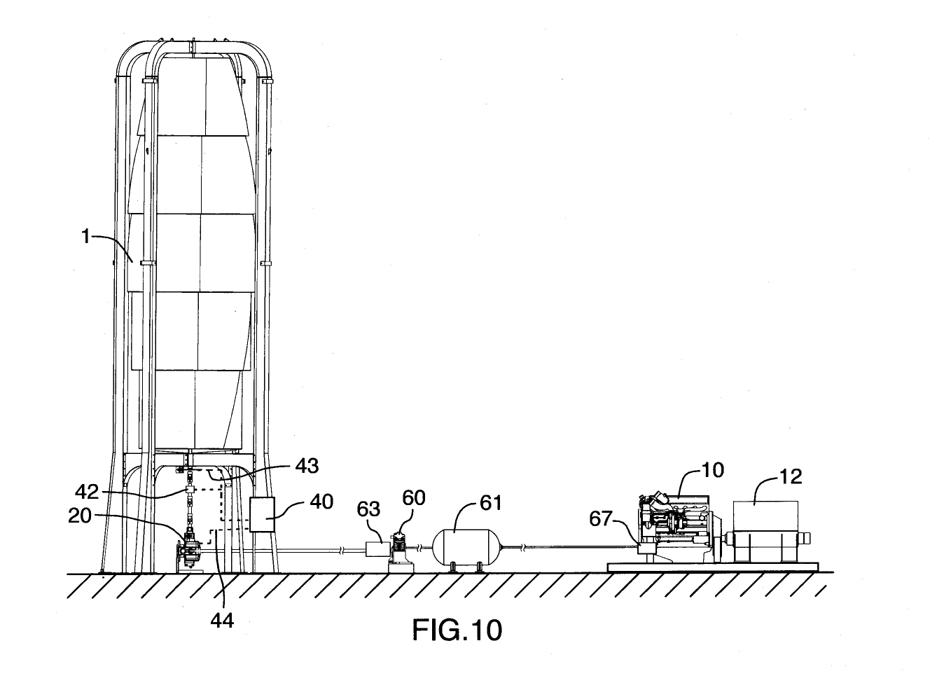

Referring to FIG. 10, an embodiment of the invention is shown wherein the embodiment of FIGS. 3b and 8 are combined. In this manner, a controller 40 is provided for varying the load applied to the turbine 1 via the hydrostatic drive system in order to maximize the wind power extracted according to prevailing environmental conditions. The controller 40 accepts control inputs from at least a torque sensor 42 and a measurement of rotational speed 43 is also provided, as previously described with reference to FIG. 3b. The controller 40 modulates the hydraulic pump 20 (via control line 44) in order to vary the load applied to the turbine 1. The controller 40 does not accept control inputs from the electricity generating means 12. Persons skilled in the art will understand that other embodiments of controllers may be provided in place of the controller 40 (for example, the controller 30 or the controller 50, as previously described with reference to FIG. 3a or 3c, respectively) without materially affecting the way in which this embodiment of the invention works.

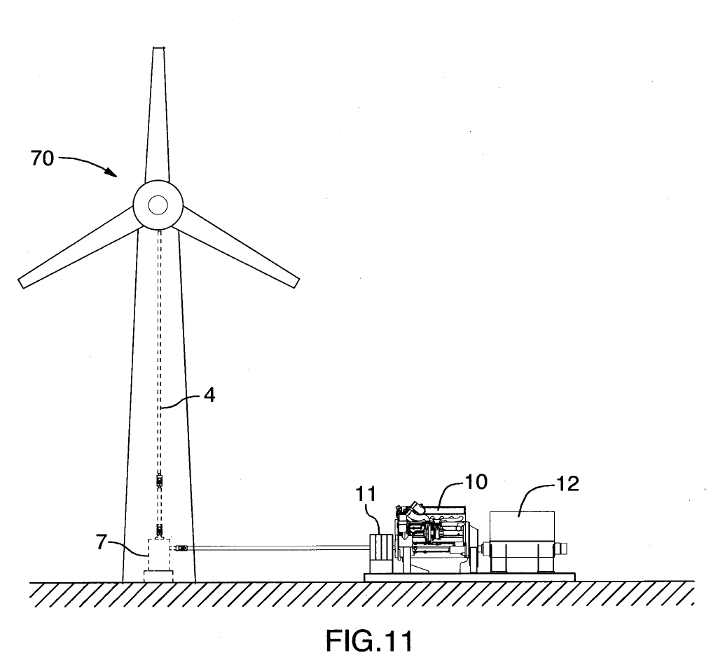

Referring to FIG. 11, an embodiment of the invention is shown wherein a horizontal axis wind turbine 70 is provided in placed of the vertical axis wind turbine 1 shown in the preceding figures. The turbine 70 is mechanically connected to the internal combustion engine 10 via a gearbox 7 that comprises a 90° elbow connection. A second 90° elbow connection (hidden in FIG. 10) is also provided at the top of the turbine 70 to transfer rotary motion about the horizontal axis of the turbine to a vertical shaft 4 of the turbine 70 and thence to the gearbox 7. This embodiment therefore requires two 90° elbow connections, both of which provide a certain amount of power loss. Persons skilled in the art will understand that a horizontal axis turbine 70 may be provided in place of the vertical axis turbine 1 shown in any of the preceding embodiments. In embodiments comprising the hydraulic pump 20, the pump may be provided at the top of the turbine 70 to accept power from the horizontal shaft thereof in order to advantageously eliminate at least one of the 90° elbow connections.

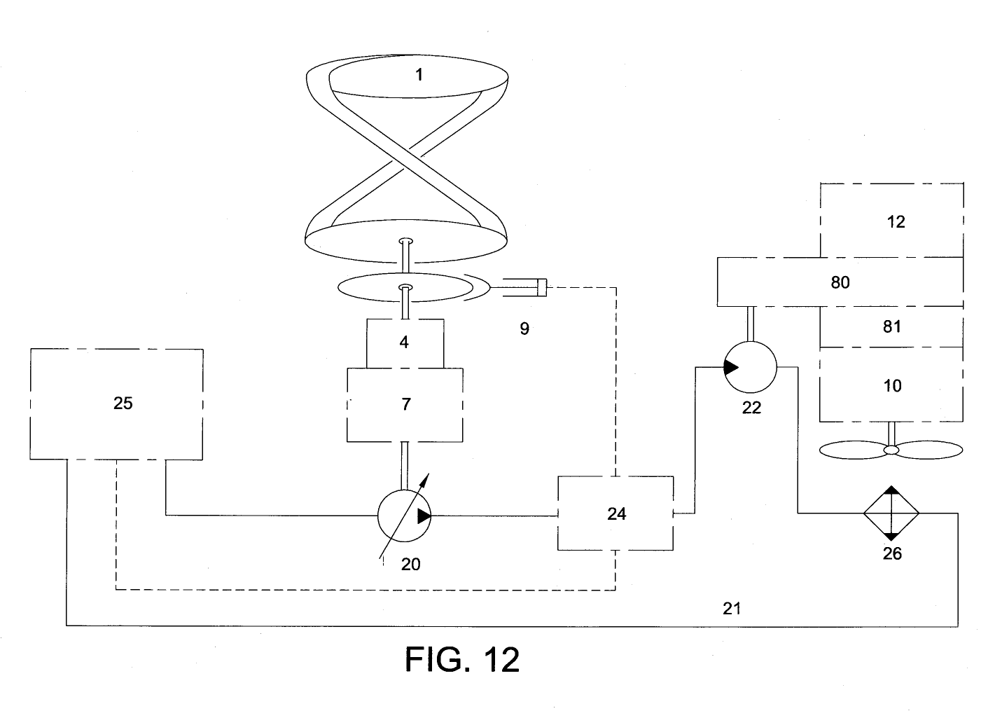

Referring to FIG. 12, a schematic representation of an alternative configuration for use with the preceding embodiments is shown. The configuration shown is with reference to the embodiment of FIG. 2, although could be applied equally to the embodiments of FIG. 3 or 9-11. In this configuration, power from the hydraulic motor 22 is supplied to the electricity generating means 12 in parallel with the internal combustion engine 10. This is accomplished through use of a splitter 80, which accepts mechanical input power from two separate input shafts and provides that power to a single output shaft. A clutch 81 is provided between the splitter 80 and the internal combustion engine 10. This configuration permits a higher power contribution from the wind turbine 1, since it is not constrained to be less than the maximum power output of the internal combustion engine 10. Thus, in this configuration, the wind turbine may be sized to provide a greater or equal power output to the internal combustion engine 10. The wind turbine may be sized such that its average power output is roughly equal to the electrical demand from the generator 12, with supplemental power being provided by the internal combustion engine 10 as needed. In periods where the demand from the electricity generating means 12 is less than the available wind power, the excess wind power may either be diverted to a physical storage medium, such as through accumulation of compressed air, hydraulic fluid, or water, or the turbine may be operated at less than its peak output power by bypassing some of the between the inlet and outlet of the pump 20. This can be accomplished through use of a pressure control unit 24, which includes valves to restrict flow and increase fluid pressure and/or to bypass flow back to the reservoir 25, as shown.

The schematic also shows some additional hydraulic components desirable in such a system, for example an oil cooler 26, a hydraulic reservoir 25 and a hydraulic brake 9 that may be controlled by the pressure control unit 24. A transmission 7 between the vertical shaft 4 and the pump 20 may optionally be provided if needed to increase the rotational speed provided to the pump.

The rotational speed of the input shafts from the hydraulic motor 22 and the internal combustion engine 10 may be matched by use of the pressure control unit 24. Alternatively, the splitter 80 may include an internal transmission, such as a CVT transmission as previously described, to match the speeds of the two input shafts.

In an alternative configuration to that shown in FIG. 12, the splitter 80 may be omitted entirely and the output of the hydraulic motor 22 may be connected to the electricity generating means 12. In this case, the internal combustion engine 10 may be connected to a booster pump (not shown) for supplying hydraulic fluid pressure as needed to the hydraulic circuit comprising the motor 22. In this way, there is no need to match the rotational speed of the hydraulic motor 22 to the internal combustion engine 10. By eliminating the additional mechanical losses of the splitter 80, an even higher proportion of power from the wind turbine may be utilized.

In the foregoing configurations, a control system is required that interfaces between the electricity generating means 12, the internal combustion engine 10 and the wind turbine 1 in order that sufficient power is provided from the various sources to satisfy the downstream electrical load. These control inputs and outputs may be incorporated within the controllers 30, 40 or 50, as previously described, for determining how much load to apply to the wind turbine 1 in order that it operates at peak power.

Persons skilled in the art will readily understand that, although this configuration is shown with an electricity generating means 12 as the load, a water pump, air compressor or other mechanical load could be substituted.

Having described preferred embodiments of the invention, it will be understood by persons skilled in the art that certain variants and equivalents can be substituted for elements described herein without departing from the way in which the invention works. It is intended by the inventor that all sub-combinations of features described herein be included in the scope of the claimed invention, even if not explicitly claimed, and that features described in connection with certain embodiments may be utilized in conjunction with other embodiments.

1. An electricity generating system comprising:
a. an electricity generating means operatively connected to an internal combustion engine; and,
b. a wind turbine operatively connected in series to the internal combustion engine by a hydraulic drive system.

2. (canceled)

3. The system according to claim 1, wherein the hydraulic drive system comprises a hydraulic pump powered by the wind turbine and a hydraulic motor fluidly connected to the hydraulic pump, the hydraulic motor mechanically connected to the internal combustion engine.

4. The system according to claim 3, wherein the hydraulic motor is connected to a camshaft of the internal combustion engine via an auxiliary power port of the engine.

5. The system according to claim 3, wherein the wind turbine is a vertical axis wind turbine.

6. The system according to claim 5, wherein the hydraulic pump is located beneath the wind turbine and vertically accepts a shaft of the wind turbine.

7. (canceled)

8. (canceled)

9. (canceled)

10. (canceled)

11. The system according to claim 1, wherein the system further comprises a controller that varies the amount of load applied to the wind turbine according to available wind energy.

12. The system according to claim 11, wherein the controller accepts a measurement of power produced by the turbine and periodically or continuously varies the load applied to the turbine in order to seek a maximum power output of the turbine.

13. The system according to claim 11, wherein the controller is programmed with a series of torque or power values for the wind turbine as a function of rotational speed, accepts a measurement of torque or power produced by the turbine, accepts a measurement of rotational speed of the turbine and periodically or continuously varies the load applied to the turbine in order to seek a maximum power output of the turbine.

14. (canceled)

15. The system according to claim 1, wherein the expected maximum power output of the wind turbine is less than 50% of the rated maximum power of the internal combustion engine.

16. A wind powered apparatus comprising:
a. a vertical axis wind turbine having a vertical shaft;
b. a hydraulic drive system comprising a hydraulic pump powered by the wind turbine and a hydraulic motor fluidly connected to the hydraulic pump, the hydraulic pump located beneath the wind turbine and vertically accepting the vertical shaft of the wind turbine; and,
c. the hydraulic motor operatively connectable to a mechanical load.

17. (canceled)

18. The apparatus of claim 16, wherein the mechanical load is an electricity generating means.

19. The apparatus of claim 16, wherein the hydraulic motor is operatively connectable in series to an internal combustion engine connected to the mechanical load.

20. The apparatus of claim 16, wherein an internal combustion engine is operatively connectable to the mechanical load in parallel with the wind turbine.

21. The apparatus of claim 20, wherein the internal combustion engine is operatively connectable to the hydraulic motor in parallel with the wind turbine.

22. The apparatus of claim 16, further comprising a controller that varies the amount of load applied to the wind turbine via the hydraulic drive system according to available wind energy.

23. A system for reducing energy consumption of a primary power source comprising:
a. a wind powered apparatus comprising a wind turbine having a hydraulic drive system comprising a hydraulic pump powered by the wind turbine and a hydraulic motor fluidly connected to the hydraulic pump, the hydraulic motor for reducing a load on the primary power source to thereby reduce energy consumption thereof; and,
b. wherein the hydraulic motor reduces load on the primary power source either by providing power directly to the primary power source or by separately satisfying a portion of the load on the primary power source.

24. The system according to claim 23, wherein the primary power source and the wind turbine are connected in parallel with a mechanical load.

25. The system according to claim 23, wherein the primary power source and the wind turbine are connected in series with a mechanical load.

26. The system according to claim 25, wherein the primary power source is an internal combustion engine and wherein the hydraulic motor provides power directly to the engine.

27. (canceled)

28. The system according to claim 23, wherein the primary power source is connected to an electricity generating means.

29. (canceled)

30. (canceled)
